(19) United States
(12) Patent Application Publication
(10) Pub. No.: US 2021/0289775 A1
(43) Pub. Date: Sep. 23, 2021

(54) THICKENER COMBINATION FOR AGROCHEMICAL (CROP PROTECTION) FORMULATIONS WITH HIGH SALT CONTENT

(71) Applicant: Bayer Aktiengesellschaft, Leverkusen (DE)

(72) Inventor: Roland DECKWER, Duesseldorf (DE)

(21) Appl. No.: 17/264,245

(22) PCT Filed: Jul. 31, 2019
(86) PCT No.: PCT/EP2019/070573

§ 371 Date: Jan. 28, 2021

(30) Foreign Application Priority Data
Jul. 31, 2018 (EP) 18186633.6

(51) Int. Cl. A01N 25/22; A01N 57/20; A01N 43/68; A01N 59/00; A01N 43/16; A01N 25/30

(52) U.S. Cl. CPC A01N 25/22; A01N 57/20; A01N 25/30; A01N 59/00; A01N 43/16; A01N 43/68

(57) ABSTRACT

The invention relates to the technical field of thickener combinations for crop protection formulations with high salt content, in particular herbicidal formulations, and formulations containing said adjuvant combinations, as well as methods for producing said formulations. In a preferred embodiment, the instant invention relates to aqueous formulations of water-soluble active ingredients, in particular aqueous formulations of saltlike active ingredients, and especially to formulations containing glufosinate and or glyfosate, in combination with at least one further water insoluble active ingredient, which is suspended in the formulation, wherein the formulations contain a high salt content.

The invention relates to the technical field of thickener combinations for crop protection formulations with high salt content, in particular herbicidal formulations, and formulations containing said adjuvant combinations, as well as methods for producing said formulations.

In a preferred embodiment, the instant invention relates to aqueous formulations of water-soluble active ingredients, in particular aqueous formulations of saltlike active ingredients, and especially to formulations containing glufosinate and or glyfosate, in combination with at least one further water insoluble active ingredient, which is suspended in the formulation, wherein the formulations contain a high salt content.

Various formulations for water soluble active ingredients are known, in particular for herbicides like glufosinate and glyphosate. However, in highly loaded formulations, the systems tend to agglomerate leading to reduced shelf life and efficacy as well as problems with the dilution and application of said formulation itself. This problem becomes even more important, if a second active ingredient in dispersion (SC formulation) is present. Standard thickeners like Xanthan do not work in such formulations and lead to agglomeration of particles.

Hence, there is a need for alternative thickener systems, which allow the preparation of high loaded formulations with a high salt content and preferably with at least one further active ingredient, which provide stable formulations which do not aggregate.

Moreover, there is a need for said formulations and for an improved process for preparation of said formulations.

The object of the instant invention is therefore to provide a thickener combination which does not show the disadvantages of the thickener systems known in the art for high loaded formulations with high salt content. Further, it is an object to provide formulations of active ingredients comprising said thickener systems as well as a process for their production.

Surprisingly it has now been found that the combination of a synthetic silicate and at least one further thickener selected from the group consisting of Celluloses, Xanthans and natural silicates, can stabilize highly loaded high salt content formulations of active ingredients, in particular herbicides.

Therefore, in one aspect of the present invention the thickener combination for agrochemical formulation comprises:

1) a synthetic silicate., and

2) a natural silicate (clay).

In another aspect of the instant invention, the thickener combination comprises

1) a synthetic silicate.,

3) a xanthan, and

4) a cellulose.

In one embodiment, the synthetic silicate 1) has a spherical structure.

Preferably, the synthetic silicate 1) has a BET surface area of 100 to 300 m²/g, more preferred of 150 to 250 m²/g, and even more preferred of 175-225 m²/g.

Further preferred the synthetic silicate 1) has an pH according to ASTM D 1208 of pH 3.0 to 5.5, more preferred from 3.5 to 5.0.

Also preferred the synthetic silicate 1) has a SiO₂-content of at least 95%, more preferred of at least 99%.

In one embodiment the natural silicate 2) has a needle shaped structure.

Preferably, the natural silicate 2) has a BET surface area of 75 to 450 m²/g, more preferred of 100 to 300 m²/g, and even more preferred of 100-200 m²/g.

Further preferred the natural silicate 2) has an pH according to ASTM D 1208 of pH 7.0 to 9.5, more preferred from 8.0 to 9.0.

Even further preferred, the naturale silicate 2) has an Oil absorption (ASTM D281) of 110 to 120, more preferred of 115.

In one embodiment the naturale silicate 2) comprises 60-65% SiO₂, about 11-14% Al₂O₃, 11-14% MgO and further metal and phosporous oxides adding up to 100%.

The BET surface area, for example, may be correlated to the volume of gas adsorbed to the surface of the particles (1 g Sample) measured at the boiling point of nitrogen (−196° C.). The amount of adsorbed gas is correlated to the total surface area of the particles including pores in the surface. The calculation is based on the BET theory. Traditionally nitrogen is used as adsorbate gas.

Preferably the ratio of 1) to 2) is from 1:5 to 5:1, more preferred, from 1:3 to 3:1, even more preferred from 1:2 to 1:2, and further preferred from 0.8:1.2 to 1.2:0.8.

If not otherwise indicated ratios always refer to weight ratio in the instant application.

In another aspect of the instant invention, the thickener combination comprises

1) a synthetic silicate.,

3) xanthan, and

4) a cellulose,

wherein the synthetic silicate has properties as described above.

In a preferred embodiment the cellulose 4) is a microfibrillar cellulose.

In a further preferred embodiment the xanthan 3) is Xanthan Gum.

Preferably the ratio of 1) to combined 3 and 4) is from 1:5 to 5:1, more preferred, from 1:3 to 3:1, even more preferred from 1:2.5 to 1:1, and further preferred from 1:2 to 1:1.

In another aspect, the instant invention provides liquid aqueous crop protectant compositions, preferably of water-soluble active crop protectant ingredients, said compositions comprising
(a) one or more water-soluble active crop protectant ingredients (type (a) active ingredients),
(b) one or more water-insoluble active crop protectant ingredients (type (b) active ingredients),
(c) optionally polar organic solvents,
(d) at least one wetting agent,
(e) at least one additive selected from the group consisting of non-ionic or anionic surfactants or dispersing aids,
(f) at least one defoamer
(g) the thickener combination as described above
(h) optionally, other customary formulation assistants, and
(i) water,

The formulations of the invention may further comprise type (b) active ingredients, which are largely insoluble in water, examples being herbicides from the group of the diphenyl ethers such as oxyfluorfen, carbamates, thiocarbamates, triphenyltin compounds and tributyltin compounds, haloacetanilides, phenoxyphenoxyalkanecarboxylic acid derivatives and heteroaryloxyphenoxyalkanecarboxylic acid derivatives, such as quinolyloxy-, quinoxalyloxy-, pyridyloxy-, benzoxalyloxy- and benzothiazolyloxyphenoxyalkanecarboxylic esters, examples being diclofop-methyl, fenoxaprop-ethyl, and fenoxaprop-P-ethyl, as well as cellulose-biosynthesis-inhibiting (CBI) herbicides such as indaziflam.

Also suitable are correspondingly insoluble active ingredients from classes of substance which normally include active ingredients of different solubilities, examples being active ingredients from the group of the cyclohexanedione derivatives, imidazolinones, pyrimidyloxypyridinecarboxylic acid derivatives, pyrimidyloxybenzoic acid derivatives, sulfonylureas, triazolopyrimidinesulfonamide derivatives, and S-(N-aryl-N-alkylcarbamoylmethyl)dithiophosphoric esters.

The stated common names for active ingredients, such as glufosinate, glyphosate, oxyfluorfen, diclofop-methyl, fenoxaprop-(P-)ethyl and others, are known to the skilled worker; see, for example, “The Pesticide Manual” British Crop Protection Council 2003; the names include the known derivatives such as salts of glufosinate and glyphosate, especially the commercially customary forms.

Correspondingly it is also possible for active ingredients to be selected from the group of the safeners, growth regulators, insecticides and fungicides to be suitable as component (b) and/or, given good water-solubility, as components (a).

Preferably, component b) is indaziflam.

Most preferably in the context of the present invention, component (b) only refers to the (1*R)-1-fluoroethyl diastereoisomer of indaziflam (CAS Reg. No. 730979-19-8), represented by the following structure (the (1*R)-1-fluoroethyl moiety is marked with an asterisk 1*R):

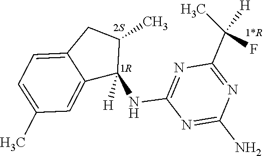 [SMILES: Cc1ccc2c(c1)[C@H](Nc1nc(N)nc([C@@H](C)F)n1)[C@@H](C)C2]

In accordance with the present invention, the herbicide combinations as defined herein or the composition comprising a herbicide combination as defined herein comprise a herbicidally effective amount of said herbicide combination and may comprise further components, for example agrochemically active compounds of a different type and/or formulation auxiliaires and/or additives customary in crop protection, or they may be employed together with these.

The type of active ingredients (a) and (b) used determine the type of pests which can be controlled by application of the crop protection compositions or agrochemical formulations. In case of herbicides the pests are undesired plants.

Preferred formulations are those comprising type (a) ingredients from the group consisting of one or more compounds of the formula (1) or salts thereof,

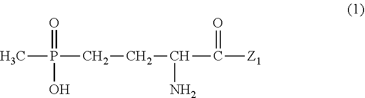

in which

Z₁ is a radical of the formula —OM, —NHCH(CH₃)CONHCH(CH₃)CO₂M or —NHCH(CH₃)CONHCH[CH₂CH(CH₃)₂]CO₂M where

M=H or a salt-forming cation,

and/or one or more compounds of the formula (2) or salts thereof,

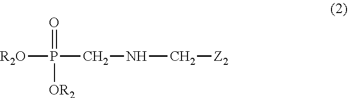

in which

Z₂ is a radical of the formula CN or CO₂R₁, in which R₁=Q or a salt-forming cation and Q=H, alkyl, alkenyl, alkoxyalkyl or C₆-C₁₀-aryl which is unsubstituted or substituted and is preferably unsubstituted or substituted by one or more radicals from the group consisting of alkyl, alkoxy, halogen, CF₃, NO₂ and CN, and

R₂ and R₃ each independently of one another are H, alkyl, C₆-C₁₀-aryl which is unsubstituted or substituted and is preferably unsubstituted or substituted by one or more radicals from the group consisting of alkyl, alkoxy, halogen, CF₃, NO₂ and CN, or are biphenylyl or a salt-forming cation.

Preferably, the carbon-containing radicals in connection with Q, R₂ or R₃, respectively have up to 10 carbon atoms, particularly preferred up to 6 carbon atoms.

The compounds of the formula (1) include an asymmetric carbon atom. The L enantiomer is regarded as the biologically active isomer. The formula (1) hence embraces all stereoisomers and mixtures thereof, particularly the racemate, and the biologically active enantiomer in each case. Examples of active ingredients of the formula (1) are as follows:
glufosinate and its ammonium salt in racemic form, i.e., 2-amino-4-[hydroxy(methyl)phosphinoyl]butanoic acid and its ammonium salt,
the L enantiomer of glufosinate and its ammonium salt,
bilanafos/bialaphos, i.e., L-2-amino-4-[hydroxy(methyl)phosphinoyl]butanoyl-L-alaninyl-L-alanine and its sodium salt.

Ammonium salt in context of the present invention in particular comprises isopropylammonium.

The racemate of glufosinate-ammonium is on its own delivered usually at doses of between 200 and 1000 g a.i./ha (i.e., grams of active ingredient per hectare). These doses, glufosinate-ammonium is particularly effective when it is taken up by green parts of the plants; see “The Pesticide Manual” 13th Edition, British Crop Protection Council 2003. Glufosinate-ammonium is used predominantly for controlling broadleaf and gramineous weeds in plantation crops and on uncultivated land and also, using special application techniques, for inter-row control in arable crops such as corn, cotton, etc. Its use is also of increasing significance in transgenic crops which are tolerant or resistant to the active ingredient.

The compounds of the formula (2) comprise N-(phosphonoalkyl)glycine and hence derivatives of the amino acid glycine. The herbicidal properties of N-(phosphonomethyl)glycine (glyphosate) are described for example in U.S. Pat. No. 3,799,758.

In crop protection formulations, glyphosate is used generally in the form of the water-soluble salts, the isopropylammonium salt in particular being of importance in connection with the present invention; see “The Pesticide Manual” 13th Edition, British Crop Protection Council 2003.

In connection with the present invention the term “polar organic solvents” (component (c)) refers for example to polar protic or aprotic polar solvents and mixtures thereof. Examples of solvents in the sense of the invention are
aliphatic alcohols, such as lower alkanols such as methanol, ethanol, propanol, isopropanol and butanol, or polyhydric alcohols such as ethylene glycol, 1-methyl-propanediol and glycerol, for example,
polar ethers such as tetrahydrofuran (THF), dioxane, alkylene glycol monoalkyl and dialkyl ethers, such as propylene glycol monomethyl ether, propylene glycol monoethyl ether, ethylene glycol monomethyl or monoethyl ether, diglyme and tetraglyme, for example;
amides such as dimethylformamide (DMF), dimethylacetamide, dimethylcaprylamide, dimethylcapramide (®Hallcomide) and N-alkylpyrrolidones;
ketones such as acetone;
esters based on glycerol and carboxylic acids, such as glyceryl mono-, di- and triacetate,
lactams;
carbonic diesters;
nitriles such as acetonitrile, propionitrile, butyronitrile and benzonitrile;
sulfoxides and sulfones such as dimethyl sulfoxide (DMSO) and sulfolane.

Also suitable in many cases are combinations of different solvents which additionally include alcohols such as methanol, ethanol, n- and isopropanol, n-, iso-, tert- and 2-butanol.

In the case of single-phase aqueous-organic solutions the wholly or largely water-miscible solvents or solvent mixtures are appropriate.

Preferred organic solvents in the sense of the present invention are polar organic solvents such as N-methylpyrrolidone and Dowanol® PM (propylene glycol monomethyl ether).

Formulations of the instant invention may comprise as wetting agents (wetters) selected from the group of alkyl poly glycosides (APGs) and lauryl ether sulfates, and lauryl ether sulfate salts, in particular sodium and ammonium salts, as well as mixtures of the aforementioned wetting agents.

Formulations of the invention comprise as component (e) anionic surface-active compounds (anionic surfactants) or dispersing agents. Examples of anionic surfactants (where EO=ethylene oxide units, PO=propylene oxide units and BO=butylene oxide units) are:
e1) anionic derivatives of fatty alcohols having 10-24 carbon atoms with 0-60 EO and/or 0-20 PO and/or 0-15 BO in any order, in the form of ether carboxylates, sulfonates, sulfates and phosphates and their inorganic (e.g., alkali metal and alkaline earth metal) and organic salts (e.g., those based on amine or alkanolamine), such as Genapol® LRO, Sandopan® grades, Hostaphat/Hordaphos® grades from Clamant;
e2) anionic derivatives of copolymers composed of EO, PO and/or BO units with a molecular weight of 400 to 10⁸, in the form of ether carboxylates, sulfonates, sulfates and phosphates and their inorganic (e.g., alkali metal and alkaline earth metal) and organic salts (e.g., those based on amine or alkanolamine);
e3) anionic derivatives of alkylene oxide adducts of C₁-C₉ alcohols, in the form of ether carboxylates, sulfonates, sulfates and phosphates and their inorganic (e.g., alkali metal and alkaline earth metal) and organic salts (e.g., those based on amine or alkanolamine);
e4) anionic derivatives of fatty acid alkoxylates in the form of ether carboxylates, sulfonates, sulfates and phosphates and their inorganic (e.g., alkali metal and alkaline earth metal) and organic salts (e.g., those based on amine or alkanolamine);
e5) salts of aliphatic, cycloaliphatic and olefinic carboxylic and polycarboxylic acids, and also alpha-sulfo fatty acid esters as are obtainable from Henkel;
e6) sulfosuccinates, alkanesulfonates, paraffinsulfonates and olefinsulfonates such as Netzer IS®, Hoe® S1728, Hostapur® OS, Hostapur® SAS from Clariant, Triton® GR7ME and GR5 from Union Carbide, Empimin® grades from Albright and Wilson, and Marlon®-PS65 from Condea.

Preferred anionic surfactants are alkyl polyglycol ether sulfates, especially fatty alcohol diethylene glycol ether sulfate (e.g., Genapol LRO®, Clariant), or alkyl polyglycol ether carboxylates (e.g., 2-(isotridecyloxypolyethyleneoxy)ethyl carboxymethyl ether, Marlowet 4538®, Hülls).

The formulations of the invention may if desired comprise nonionic and/or cationic surfactants or dispersing agents as component (e).

Examples of nonionic surfactants (for surfactant component e) are:
e7) fatty alcohols having 10-24 carbon atoms with 0-60 EO and/or 0-20 PO and/or 0-15 BO in any order. Examples of such compounds are Genapol® C., L, O, T, UD, UDD and X grades from Clariant, Plurafac® and Lutensol® A, AT, ON and TO grades from BASF, Marlipal® 24 and O13 grades from Condea, Dehypon® grades from Henkel, and Ethylan® grades from Akzo-Nobel such as Ethylan DC 120;
e8) fatty acid alkoxylates and triglyceride alkoxylates such as the Serdox NOG grades from Condea or the Emulsogen® grades from Clamant;
e9) fatty acid amide alkoxylates such as the Comperlan® grades from Henkel or the Amam® grades from Rhodia;
e10) alkylene oxide adducts of alkynediols such as the Surfynol® grades from Air Products; sugar derivatives such as amino sugars and amido sugars from Clamant,
e11) glucitols from Clamant,
e12) alkylpolyglycosides, e.g. in the form of the APG® grades from Henkel;
e13) sorbitan esters in the form of the Span® or Tween® grades from Uniqema;
e14) cyclodextrin esters or ethers from Wacker;
e15) surface-active cellulose derivatives and algine, pectin and guar derivatives such as the Tylose® grades from Clamant, the Manutex® grades from Kelco, and guar derivatives from Cesalpina;
e16) polyol-based alkylene oxide adducts such as Polyglykol® grades from Clamant;
e17) surface-active polyglycerides and their derivatives from Clamant.

Examples of cationic surfactants (for surfactant component e) are alkylene oxide adducts of fatty amines and corresponding quaternary ammonium compounds having 8 to 22 carbon atoms such as, for example, the Genamin® C., L, O and T grades from Clariant.

Also possible if desired are surface-active zwitterionic compounds such as taurides, betaines and sulfobetaines in the form of Tegotain® grades from Goldschmidt and Hostapon® T and Arkopon® T grades from Clamant (for surfactant component e).

The formulations of the invention comprise defoamers of component (f). The defoamers 1) according to the present the invention comprise defoamers from the group consisting of linear polydimethylsiloxanes. Preferably, the defoamers have an average dynamic viscosity, measured at 25° C., in the range from 1000 to 8000 mPas (mPas=millipascal-second), preferably 1000 to 6000 mPas. The viscosity can be measured by a rotational shear rheometer, e.g. with a Brookfield RVT viscometer, needle no. 3, 20 rpm, in accordance with the ISO 2555 standard.

Further, in another embodiment, the said defoamers additionally contain silica. By silica is meant, for example, forms/modifications such as polysilicic acids, meta-silicic acid, ortho-silicic acid, silica gel, silicic acid gels, kieselguhr, precipitated SiO2 etc.

Defoamers from the group of the linear polydimethylsiloxanes include as their chemical backbone a compound of the formula HO—[Si(CH3)2-O-]n-H, in which the end groups are modified—etherified, for example—or, in general, are joined to the groups —Si(CH3)3.

The amount of silica can be modified within a wide range and is generally in the range from 0.1 to 10 percent by weight, preferably 0.2 to 5 percent by weight, in particular 0.2% to 2% by weight of silica, based on the weight of polydimethylsiloxane.

Examples of defoamers of this kind are ÒRhodorsil Antifoam 416 (Rhodia) and ÒRhodorsil Antifoam 481 (Rhodia).

ÒRhodorsil Antifoam 416 is a medium-viscosity silicone oil having a dynamic viscosity at 25° C. of about 1500 mPas and containing a surfactant and silica. Because of the surfactant content the density is reduced as compared with the unadditized silicone oil, and amounts to about 0.995 g/cm3.

Rhodorsil Antifoam 481 is a medium-viscosity silicone oil having a dynamic viscosity at 25° C. of about 4500 mPas and containing silica. The density amounts to about 1.045 g/cm3.

The silicone oils can also be used as emulsions, e.g SAG 1572 Silicone Antifoam Emulsion by Momentive, Antifoam EM SE 39 (silicone-based defoamer emulsion without silica gel, Wacker), Antimussol 4459-2 (silicone-based defoamer emulsion without silica gel, Clariant), Rhodorsil 1824 (silicone-based defoamer emulsion without silica gel, Rhodia).

Preference is given to the use of medium-viscosity defoamers based on polydimethylsiloxanes having a dynamic viscosity, measured at 25° C., in the range from 1000 to 5000 mPas, preferably 1200 to 5000 mPas, in particular emulsion defoamers like ÒSAG 1572.

The formulations of the invention also comprise fatty acid esters (g), which are described above as 2).

The thickener combination g) is as described above.

Examples of customary formulation assistants (h) are inert materials, such as stickers, dispersants, emulsifiers, penetrants, preservatives, and frost protectants—e.g. 1, 2 propane diol, ethylene glycol or glycerine—, fillers, carriers, dyes and colorants, evaporation inhibitors and pH modifiers (buffers, acids and bases) or viscosity modifiers (e.g., thickeners).

The assistants needed to prepare the above formulations, such as surfactants in particular, are known in principle and are described for example in: McCutcheon's “Detergents and Emulsifiers Annual”, MC Publ. Corp., Ridgewood N.J.; Sisley and Wood “Encyclopedia of Surface Active Agents”, Chem. Publ. Co. Inc., N.Y. 1964; Schönfeldt, “Grenzflächenaktive Äthylenoxidaddukte”, Wiss. Verlagsgesellschaft, Stuttgart 1976; Winnacker-Küchler, “Chemische Technologie”, Volume 7, C. Hanser-Verlag, Munich, 4th Edition 1986, and references cited in each of these.

With the aid of mixtures of components it is possible accordingly to prepare preferably concentrated low-foam liquid aqueous preparations of saltlike active crop protectant ingredients, such as glufosinate-ammonium or glyphosate salts, which comprise
(a) 20% to 65%, preferably 25% to 60% and in particular 30% to 50% by weight of at least one water-soluble active crop protectant ingredients (type (a) ingredients),
(b) 0.1 to 5.0%, preferably 0.2 to 2.0% and in particular 0.3 to 1.8% by weight of at least one water-insoluble active crop protectant ingredients (type (b) ingredients),
(c) 0% to 20%, more preferrd 0 to 15%, and most preferred 1 to 15% by weight of polar organic solvents,
(d) 1% to 50%, more preferred 5 to 45%, and most preferred 10 to 38% by weight of at least one wetting agent,
(e) 0.2 to 7%, preferably 0.5 to 3.5%, and more preferred 0.6.to 1.5% by weight of at least one disperging agent,
(f) 0.01% to 3%, preferably 0.05% to 2% and in particular 0.1% to 1.5% by weight of at least one defoamer,
(g) 0.3% to 8%, preferably 0.4% to 3.0% and in particular 0.5% to 2.0% by weight of the thickener combination according to the instant inventions,
(h) 0.001 to 15%, preferably 0.01 to 10% and preferably 0.1 to 8.0% by weight of customary formulation assistants,
(i) water to add up to 100%,

In the above formulation components a) to i) add up to 100%, wherein the water content is at least 5% water.

Preferably, crop protectant compositions in the instant application have a water content of at least 5% by weight. In one embodiment the water content is between 5% and 78.38% by weight. In another embodiment the water content is between 6% and 52% by weight (w/w).

In one embodiment where a) is a glyphosate salt, preferably a) is contained from 30 to 60% by weight, preferably from 30 to 50% by weight.

In one embodiment where a) is a glufosinate salt, preferably a) is contained from 20 to 50% by weight, preferably from 30 to 40% by weight.

In one embodiment in the formulation the thickener combination g) comprises 1) and 2) and wetting agent c) is preferably present in 1 to 20% by weight, more preferred in 5 to 20% by weight, and most preferred in 8-12% by weight.

In one embodiment in the formulation the thickener combination g) comprises 1). 3) and 4 and wetting agent d) is preferably present in 5 to 60% by weight, more preferred in 15 to 45% by weight, and most preferred in 20 to 40% by weight. In a further preferred embodiment in this case a) is a glufosinate salt.

In one embodiment the thickener combination comprises 0.2% Xanthan, 0.5% synthetic silicate and 0.8% microfibrillar cellulose based on the total formulation respectively.

In one embodiment the thickener combination comprises 0.25% natural silicate and 0.27% synthetic silicate and 0.8% microfibrillar cellulose based on the total formulation respectively.

In one embodiment the thickener combination comprises 0.2% Xanthan, 0.5% synthetic silicate and 0.8% microfibrillar cellulose based on the total formulation respectively.

If not indicated otherwise % in the present application refers to % by weight.

Examples of customary formulation assistants (h) are the specified inert materials, frost protectants, evaporation inhibitors, preservatives, colorants, etc.; preferred formulation assistants (g) are
frost protectants and evaporation inhibitors such as glycerol or ethylene glycol, in an amount of 2% to 10% by weight, for example, and
preservatives, e.g., Mergal K9N® (Riedel) or Cobate C® 1,2-Benzisothiazolin-3-on (or its sodium salt).

The liquid formulations or suspensions of the invention can be prepared by methods which are customary in principle, i.e., by mixing the components with stirring or shaking or by means of static mixing methods. The liquid formulations obtained are stable with good storage properties.

The liquid formulations comprising active ingredient and the adjuvant formulations are low-foam formulations with good storage properties. In many cases they have very favorable technical properties on application. By way of example the formulations are distinguished by a low tendency to aggregate, e.g. during storage,

Accordingly the formulations of the invention are especially suitable for use in crop protection where the formulations are applied to the plants, to parts of plants or to the area under cultivation.

In the case of herbicidal ingredients (a) and/or (b) the formulations are very suitable for controlling unwanted plant growth both on uncultivated land and in tolerant crops.

Materials Used:

| Compound | Company | Function | Chemical description |
|---|---|---|---|
| Glyphosate-IPA | | Active ingredient | Glyphosate Isopropylammonium salt |
| Glufosinate-Ammonium | | Active ingredient | |
| Indaziflam | | Active ingredient | |
| Enviomet WT 8519 | Innospec | Wetting agent | Blend of Ammonium Laurylethersulfate and an Alkylpolyglucoside |
| Genapol LRO | Clariant | Wetting agent | Sodium Lauryl Ether Sulfate (70%) |
| Agnique PG 8105 | BASF | Wetting agent | Alkylpolyglucoside (60%) |
| Oparyl MT804 | Bozetto | Dispersing agent | Sodium salt of dibutylnaphthalene sulfonate |
| Pluronic PE 10500 | BASF | Dispersing agent | Polyethyleneoxide-Polypropylene oxide- Polyethyleneoxide-Block- |
| | | | copolymer |
| Attagel 50 | BASF | Thickener | Aluminum magnesium hydrosilicate, Attapulgite |
| Santaxiane CX911 | Cargill | Thickener | Xanthan Gum |
| Aerosil 200 | Evonik | Thickener | Synthetic fumed silica, pyrogenic |
| Exilva MFC P01-L | Borregaard | Thickener | Microfibrillar Cellulose |
| Veegum K | Borregaard | Thickener | Microfibrillar Cellulose |
| Kelzan BT | Kelco | Thickener | Xanthan Gum |
| Silfoam SE 39 | Wacker | Anti-foaming agent | Mixture of Polydimethylsiloxane and silica, emulsion in water |
| Silcolapse 454 | Bluestar | Anti-foaming agent | Mixture of Polydimethylsiloxane and silica |
| | Silicones | | |
| Silcolapse 482 | Bluestar | Anti-foaming agent | Mixture of Polydimethylsiloxane and silica |
| | Silicones | | |
| Proxel GXL | Arch Chemicals | Preservative | 1,2-Benzisothiazolin-3-on as sodium salt (20% solution) |
| Glycerin | Commodity | Anti-freezing agent | 1,2,3 Propantriol |

Formulations According to the Invention:

### EXAMPLE 1

| Material name | % w/w |
|---|---|
| Glyphosate-IPA | 44.63 |
| Indaziflam | 1.65 |
| Enviomet WT 8519 | 10.00 |
| Oparyl MT804 | 1.02 |
| Pluronic PE 10500 | 0.17 |
| Attagel 50 | 0.25 |
| Aerosil 200 | 0.27 |
| Silfoam SE 39 | 0.10 |
| Silcolapse 482 | 0.10 |
| Proxel GXL | 0.01 |
| Glycerin | 5.00 |
| Water | 36.81 |

### EXAMPLE 2

| Material name | % w/w |
|---|---|
| Glyphosate-IPA | 30.25 |
| Indaziflam | 0.34 |
| Enviomet WT 8519 | 10.00 |
| Oparyl MT804 | 1.00 |
| Pluronic PE 10500 | 0.03 |
| Santaxiane CX911 | 0.20 |
| Aerosil 200 | 0.50 |
| Exilva MFC P01-L | 0.80 |
| Silfoam SE 39 | 1.00 |
| Silcolapse 454 | 0.10 |
| Proxel GXL | 0.01 |
| Glycerin | 5.00 |
| Water | 51.07 |

### EXAMPLE 3

| Material name | % w/w |
|---|---|
| Glufosinate-Ammonium | 30.25 |
| Indaziflam | 0.65 |
| Genapol LRO | 28.29 |
| Agnique PG 8105 | 8.70 |
| Atlox 4915 | 2.00 |
| Kelzan BT | 0.20 |
| Aerosil 200 | 0.50 |
| Veegum K | 0.80 |
| Silfoam SE 39 | 1.01 |
| Proxel GXL | 0.01 |
| Propylene glycol | 5.00 |
| Water | 6.18 |

All of above examples show low aggregation of the formulations.

1. A thickener combination for an agrochemical formulation comprising:
1) a synthetic silicate, and
2) a natural silicate (optionally clay).

2. A thickener combination for an agrochemical formulation comprising:
1) a synthetic silicate,
3) xanthan, and
4) a cellulose.

3. Thickener combination according to claim 1, wherein synthetic silicate 1) has a spherical structure.

4. Thickener combination according to claim 1, wherein the natural silicate 2) has a needle shaped structure.

5. Thickener combination according to claim 1, wherein the ratio of 1) to 2) is from 1:5 to 5:1.

6. Thickener combination according to claim 2, wherein the ratio of 1) to combined 3 and 4) is from 1:5 to 5:1.

7. A liquid aqueous crop protectant composition comprising:
(a) one or more water-soluble active crop protectant type (a) ingredients,
(b) one or more water-insoluble active crop protectant type (b) ingredients,
(c) optionally polar organic solvents,
(d) at least one wetting agent,
(e) at least one additive selected from the group consisting of non-ionic or anionic surfactants or dispersing aids,
(f) at least one defoamer,
(g) the thickener combination according to claim 1,
(h) optionally, one or more other customary formulation assistants, and
(i) water.

8. The crop protectant composition according to claim 7, wherein component a) is selected from the group consisting of glyphosate and glufosinate and salts thereof.

9. The crop protectant composition according to claim 7, wherein component b) is indaziflam.

10. The crop protectant composition as claimed in claim 7 comprising
(a) 20% to 65%, optionally 25% to 60% and optionally 30% to 50% by weight of at least one water-soluble active crop protectant type (a) ingredients,
(b) 0.1 to 5.0%, optionally 0.2 to 2.0% and optionally 0.3 to 1.8% by weight of at least one water-insoluble active crop protectant type (b) ingredients,
(c) 0% to 20%, optionally 0 to 15%, and optionally 1 to 15% by weight of polar organic solvents,
(d) 1% to 50%, optionally 5 to 45%, and optionally 10 to 38% by weight of at least one wetting agent,
(e) 0.2 to 7%, optionally 0.5 to 3.5%, and optionally 0.6.to 1.5% by weight of at least one dispersing agent,
(f) 0.01% to 3%, optionally 0.05% to 2% and optionally 0.1% to 1.5% by weight of at least one defoamer,
(g) 0.3% to 8%, optionally 0.4% to 3.0% and optionally 0.5% to 2.0% by weight of the thickener combination,
(h) 0.001 to 15%, optionally 0.01 to 10% and optionally 0.1 to 8.0% by weight of one or more customary formulation assistants, and
(i) water to add up to 100%.

11. The crop protectant composition according to claim 10, wherein the thickener combination comprises 0.2% Xanthan, 0.5% synthetic silicate and 0.8% microfibrillar cellulose based on the total formulation respectively.

12. The crop protectant composition according to claim 10, wherein the thickener combination comprises 0.25% natural silicate and 0.27% synthetic silicate and 0.8% microfibrillar cellulose based on the total formulation respectively.

13. A product comprising the thickener composition of claim 1 for a crop protection formulation.
